(19) United States
(12) Patent Application Publication
(10) Pub. No.: US 2007/0300311 A1
(43) Pub. Date: Dec. 27, 2007

(54) Information processing system, information processing apparatus, program, and recording medium

(76) Inventors: Kazumi Hirano, Tokyo (JP); Ken Yajima, Tokyo (JP); Naoya Okamoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/702,522

(22) Filed: Feb. 6, 2007

(30) Foreign Application Priority Data
Mar. 3, 2006 (JP) 2006-057688

(51) Int. Cl. G06F 21/22

(52) U.S. Cl. 726/33

(57) ABSTRACT

An information processing system includes a first information processing apparatus and a second information processing apparatus. The first information processing apparatus includes storing means configured to store a predetermined content or predetermined software, acquiring means configured to acquire the predetermined content or the predetermined software, and transmitting means configured to transmit the acquired predetermined content or the acquired predetermined software. The second information processing apparatus includes acquiring means configured to acquire rights management information managing the use of the predetermined content or the predetermined software, from a read-only recording medium having the rights management information stored therein, receiving means configured to receive the predetermined content or the predetermined software transmitted from the first information processing apparatus, and executing means configured to reproduce the predetermined content or execute the predetermined software, using the rights management information.

### CROSS REFERENCES TO RELATED APPLICATIONS

The present invention contains subject matter related to Japanese Patent Application JP 2006-057688 filed in the Japanese Patent Office on Mar. 3, 2006, the entire contents of which are incorporated herein by reference.

### BACKGROUND OF THE INVENTION

1. Field of the Invention

The present invention relates to information processing systems, information processing apparatuses, information processing methods, programs, and recording media. In particular, the present invention relates to an information processing system, an information processing apparatus, an information processing method, a program, and a recording medium which facilitate the use of a content or software desired by a user.

2. Description of the Related Art

In recent years, attention has been focused on services which provide multimedia contents such as moving images and music (hereinafter simply referred to as contents) or software such as game application programs and music-player application programs to apparatuses configured to reproduce the contents and to execute the software.

In such services, with a view to expanding the market, contents and software are provided not only to dedicated apparatuses such as game apparatuses but also to client apparatuses with versatility such as personal computers.

When a content or software is provided to a client apparatus, the content or software may be stored in a hard disk or a flash memory. However, in many cases, the content or the software is stored in a read-only recording medium such as a CD-ROM (compact disc read-only memory) or a DVD-ROM (digital versatile disc ROM) and then provided to the client apparatus, with a view to preventing unauthorized duplication using the client apparatus.

In this case, as illustrated in FIG. 1, an encrypted content or encrypted software is stored in a read-only recording medium 11 together with rights management information used for reproducing the content or executing the software. A client apparatus 12 decrypts the encrypted content to be reproduced or the encrypted software to be executed, using the rights management information stored in the recording medium 11.

For example, Japanese Unexamined Patent Application Publication No. 2005-322362 discloses a client apparatus which acquires and executes a program associated with a content stored in a read-only recording medium while the content is being reproduced. However, in this client apparatus, the acquisition and execution of the program associated with the content are restricted for each information unit in the content to be reproduced. Thus, when a predetermined part of the content is reproduced, only a program that is associated with the part can be executed.

### SUMMARY OF THE INVENTION

In such known techniques described above, when a content or software is updated, a user has to obtain a new recording medium that stores the updated content or software. There is a case where a content or software and associated rights management information are stored in a client apparatus and reproduction of the content or execution of the software is managed using the rights management information. In this case, every time the content or the software is updated, the user has to obtain the update content or software by means of downloading or the like so as to overwrite the stored content or software.

In addition, a content or software desired by a client apparatus may not be operable if the client apparatus is not compatible with the content or software. Therefore, a provider of the content or software has to prepare a plurality of content data or software data for the same content or software for individual types (specifications) of client apparatus, so that all types of client apparatus can reproduce the content or execute the software.

When a content or software prepared for individual types of client apparatus is distributed to one client apparatus, the provider stores content data or software data for the type of client apparatus in one recording medium or stores a plurality of content data or software data prepared for all types of client apparatus in one recording medium. This procedure of content or software distribution is expensive.

In addition, a user who receives the distributed content or software has to select a recording medium in which content data or software data is compatible with his or her client apparatus or select a content or software that is compatible with the client apparatus from among contents or software stored in a recording medium.

Further, there may be a case where a content or software that is associated with a predetermined content or software stored in a recording medium is stored in a different location such as another recording medium or a separate apparatus. In order to reproduce the associated content or to execute the associated software in this case, rights management information of the associated content or software, which is different from that of the predetermined content or software, is necessary.

This results in complexity in managing contents or software for the provider. In addition, the user has to perform complicated operations to reproduce a plurality of associated contents or execute a plurality of pieces of associated software.

Thus, it is not easy to reproduce desired contents and execute desired software in a client apparatus.

The present invention has been made in view of the above circumstances. Accordingly, there is a need for a technique which facilitates reproduction of desired contents and execution of desired software.

An information processing system according to a first aspect of the present invention includes a first information processing apparatus and a second information processing apparatus, wherein the first information processing apparatus includes storing means configured to store a predetermined content or predetermined software, acquiring means configured to acquire the predetermined content or the predetermined software, and transmitting means configured to transmit the acquired predetermined content or the acquired predetermined software, and wherein the second information processing apparatus includes acquiring means configured to acquire rights management information managing the use of the predetermined content or the predetermined software, from a read-only recording medium having the rights management information stored therein, receiving means configured to receive the predetermined content or the predetermined software transmitted from the first information processing apparatus, and executing means configured to reproduce the predetermined content or execute the predetermined software, using the rights management information.

According to the first aspect of the present invention, in the first information processing apparatus, a predetermined content or predetermined software is stored, and the predetermined content or predetermined software is acquired, and the acquired predetermined content or predetermined software is transmitted. In the second information processing apparatus, rights management information is acquired from a read-only recording medium having stored therein the rights management information managing the use of the predetermined content or the predetermined software, the predetermined content or the predetermined software transmitted from the first information processing apparatus is received, and the predetermined content is reproduced or the predetermined software is executed, using the rights management information.

An information processing apparatus according to a second aspect of the present invention includes acquiring means configured to acquire rights management information managing the use of a predetermined content or predetermined software, from a read-only recording medium having stored therein the rights management information and not having stored therein the predetermined content or the predetermined software, and executing means configured to obtain the predetermined content or the predetermined software and to reproduce the predetermined content or execute the predetermined software, using the acquired rights management information.

The executing means decrypts the predetermined content or the predetermined software, which has been encrypted, using the rights management information, so as to reproduce the predetermined content or execute the predetermined software.

The acquiring means further acquires information specifying the predetermined content or the predetermined software, from the read-only recording medium, and the acquiring means further includes receiving means configured to receive the predetermined content or the predetermined software which is specified by the acquired information.

The information processing apparatus further includes storing means configured to store the received predetermined content or the received predetermined software and determining means configured to determine whether or not the predetermined content or the predetermined software which is specified by the information has been updated. When the predetermined content or the predetermined software has been updated, the receiving means further receives the updated predetermined content or the updated predetermined software. When the predetermined content or the predetermined software has not been updated, the executing means reproduces the predetermined content stored in the storing means or executes the predetermined software stored in the storing means.

The acquiring means acquires the rights management information read out from the read-only recording medium by a reading apparatus.

An information processing method, a program, or a recording medium according to the second aspect of the present invention includes the steps of acquiring rights management information managing the use of a predetermined content or predetermined software, from a read-only recording medium having stored therein the rights management information and not having stored therein the predetermined content or the predetermined software, and obtaining the predetermined content or the predetermined software and reproducing the predetermined content or executing the predetermined software, using the acquired rights management information.

According to the second aspect of the present invention, rights management information managing the use of a predetermined content or predetermined software is acquired from a read-only recording medium having stored therein the rights management information and not having stored therein the predetermined content or the predetermined software, and the predetermined content or the predetermined software is obtained and the predetermined content is reproduced or the predetermined software is executed, using the acquired rights management information.

According to an embodiment of the present invention, a content can be reproduced and software can be executed. Particularly, according to the first aspect of the present invention, the reproduction of the content and the execution of the software can be performed with increased simplicity.

According to an embodiment of the present invention, a content can be reproduced and software can be executed. Particularly, according to the second aspect of the present invention, the reproduction of the content and the execution of the software can be performed with increased simplicity.

### BRIEF DESCRIPTION OF THE DRAWINGS

FIG. 1 illustrates reproduction of a content stored in a recording medium and execution of software stored in a recording medium which are performed by a known client apparatus;

FIG. 2 is a block diagram illustrating a configuration of a distribution system according to an embodiment of the present invention;

FIG. 3 shows flowcharts illustrating procedures of game executing processing and game transmission processing;

FIG. 4 illustrates an example of server information;

FIG. 5 illustrates an example of a content identifier of a game;

FIG. 6 illustrates an example of apparatus information;

FIG. 7 illustrates an example of meta information of a game;

FIG. 8 shows flowcharts illustrating procedures of moving image reproduction processing and moving image transmission processing;

FIG. 9 illustrates an example of a content identifier of a moving image;

FIG. 10 illustrates an example of meta information of a moving image;

FIG. 11 illustrate another system configuration;

FIG. 12 shows flowcharts illustrating procedures of rights management information transmission processing, game execution processing, and game transmission processing;

FIG. 13 shows flowcharts illustrating procedures of rights management information transmission processing, game execution processing, and game transmission processing;

FIG. 14 shows flowcharts illustrating procedures of moving image reproduction processing and moving image transmission processing;

FIG. 15 is a block diagram illustrating a configuration of a distribution system according to an embodiment of the present invention;

FIG. 16 shows flowcharts illustrating procedures of moving image reproduction processing and transmission processing; and

FIG. 17 is a block diagram illustrating a configuration of a personal computer.

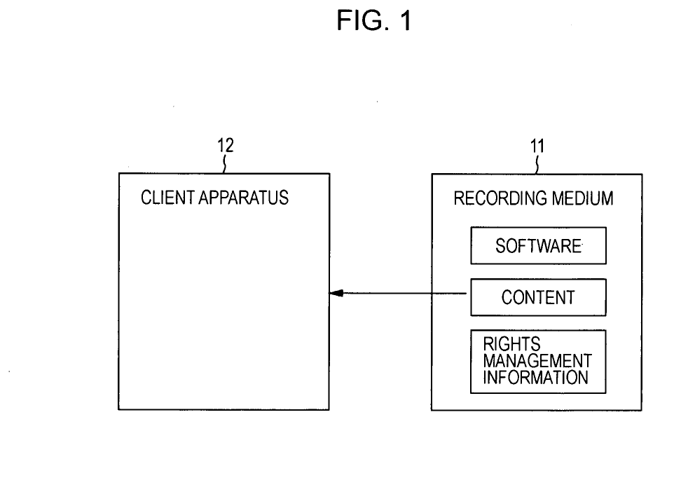

### DESCRIPTION OF THE PREFERRED EMBODIMENTS

Before describing an embodiment of the present invention, the correspondence between the features of the present invention and the embodiments disclosed in this specification or the drawings is discussed below. This description is intended to assure that embodiments supporting the present invention are described in this specification. Thus, even if an embodiment in the following description is not mentioned as relating to a certain feature of the present invention, that does not necessarily mean that the embodiment does not relate to that feature of the present invention. Conversely, even if an embodiment is described herein as relating to a certain feature of the present invention, that does not necessarily mean that the embodiment does not relate to other features of the present invention.

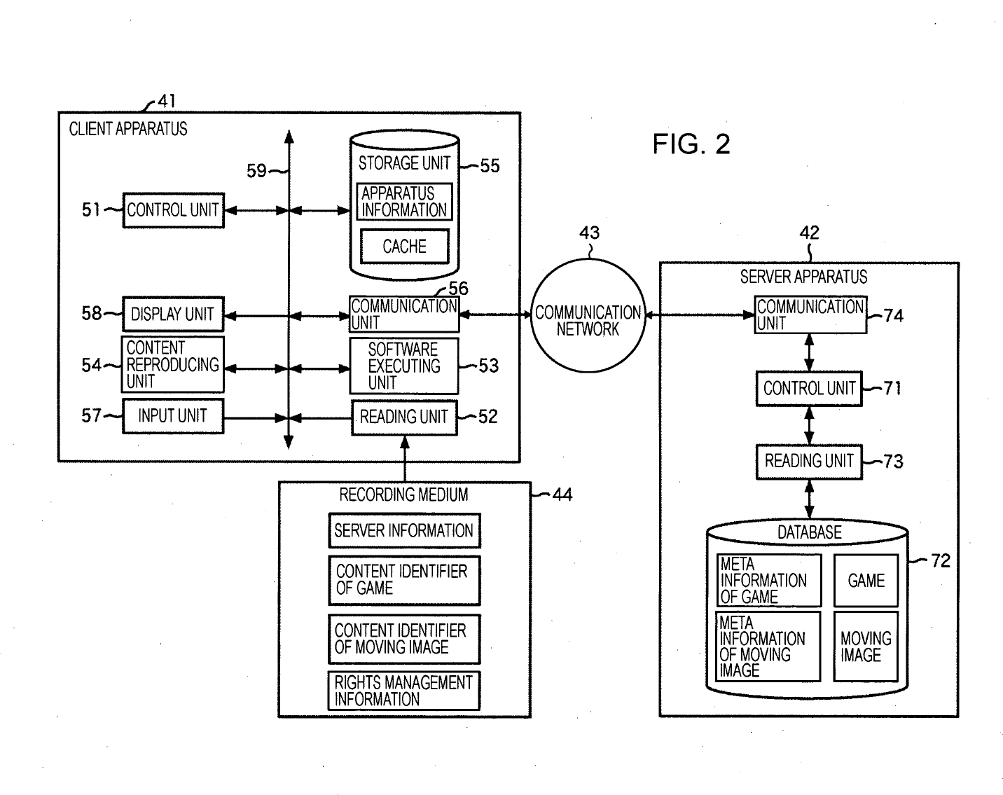

An information processing system according to a first aspect of the present invention includes a first information processing apparatus (for example, a server apparatus 42 in FIG. 2) and a second information processing apparatus (for example, a client apparatus 41 in FIG. 2). In this system, the first information processing apparatus includes storing means (for example, a database 72 in FIG. 2) configured to store a predetermined content or predetermined software, acquiring means (for example, a reading unit 73 in FIG. 2) configured to acquire the predetermined content or the predetermined software, and transmitting means (for example, a communication unit 74 in FIG. 2) configured to transmit the acquired predetermined content or the acquired predetermined software. The second information processing apparatus includes acquiring means (for example, a reading unit 52 in FIG. 2) configured to acquire rights management information managing the use of the predetermined content or the predetermined software, from a read-only recording medium having the rights management information stored therein, receiving means (for example, a communication unit 56 in FIG. 2) configured to receive the predetermined content or the predetermined software transmitted from the first information processing apparatus, and executing means (for example, a software executing unit 53 or a content reproducing unit 54 in FIG. 2) configured to reproduce the predetermined content or execute the predetermined software, using the rights management information.

An information processing apparatus according to a second aspect of the present invention includes acquiring means (for example, the reading unit 52 in FIG. 2) configured to acquire rights management information managing the use of a predetermined content or predetermined software, from a read-only recording medium (for example, a recording medium 44 in FIG. 2) having stored therein the rights management information and not having stored therein the predetermined content or the predetermined software, and executing means (for example, the software executing unit 53 or the content reproducing unit 54 in FIG. 2) configured to obtain the predetermined content or the predetermined software and to reproduce the predetermined content or execute the predetermined software, using the acquired rights management information.

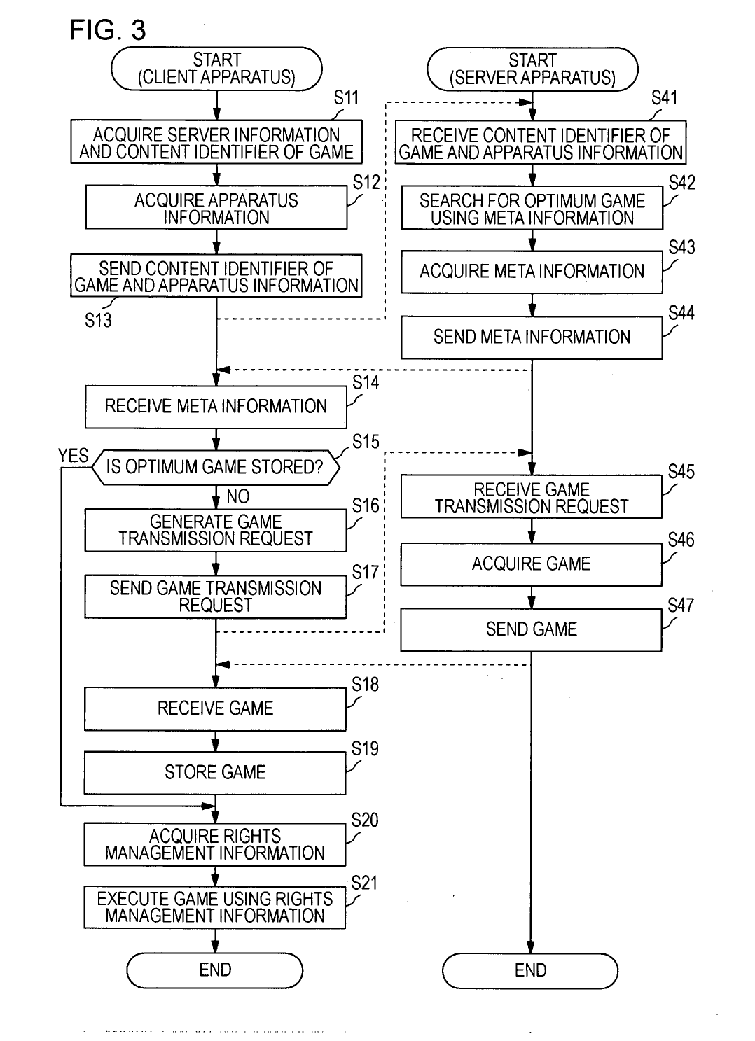

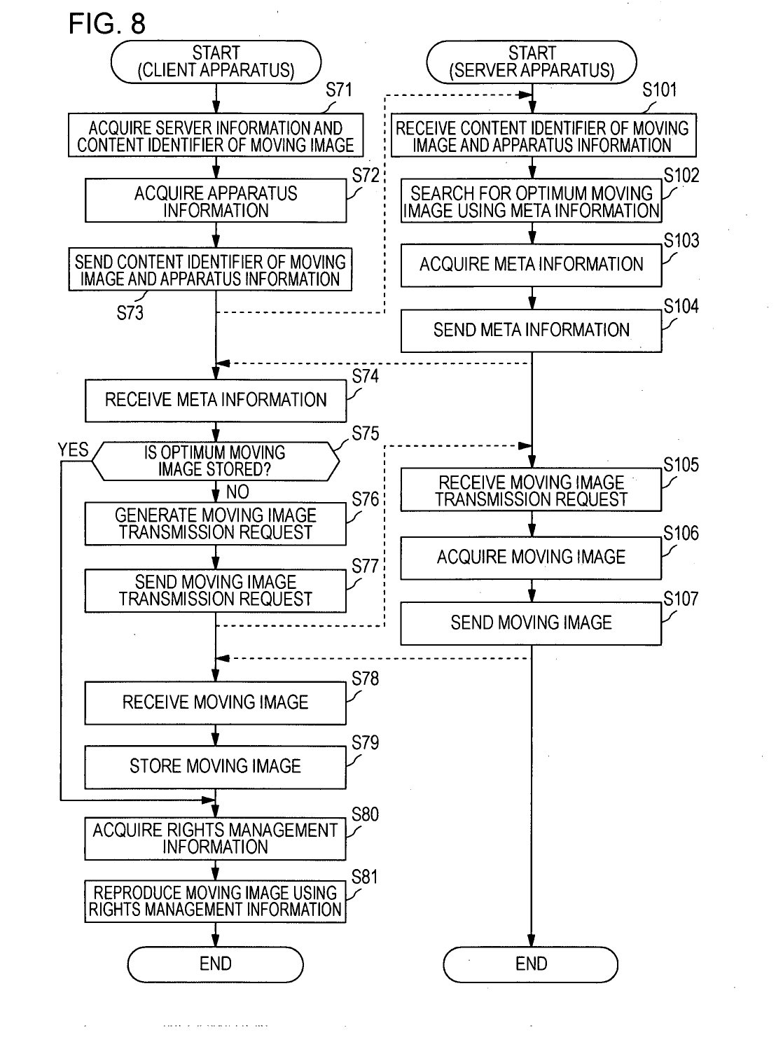

The executing means decrypts the predetermined content or the predetermined software, which has been encrypted, using the rights management information, so as to reproduce the predetermined content or execute the predetermined software (for example, processing of STEP S21 in FIG. 3 or processing of STEP S81 in FIG. 8).

The acquiring means further acquires information specifying the predetermined content or the predetermined software, from the read-only recording medium (for example, processing of STEP S11 in FIG. 3 or processing of STEP S71 in FIG. 8), and the acquiring means further includes receiving means (for example, the communication unit 56 in FIG. 2) configured to receive the predetermined content or the predetermined software which is specified by the acquired information.

The information processing apparatus further includes storing means (for example, a storage unit 55 in FIG. 2) configured to store the received predetermined content or the received predetermined software and determining means (for example, a control unit 51 in FIG. 2) configured to determine whether or not the predetermined content or the predetermined software which is specified by the information has been updated. When the predetermined content or the predetermined software has been updated, the receiving means further receives the updated predetermined content or the updated predetermined software (for example, processing of STEP S18 in FIG. 18 or processing of STEP S78 in FIG. 8). When the predetermined content or the predetermined software has not been updated, the executing means reproduces the predetermined content stored in the storing means or executes the predetermined software stored in the storing means (for example, processing of STEP S21 in FIG. 3 or processing of STEP S81 in FIG. 8).

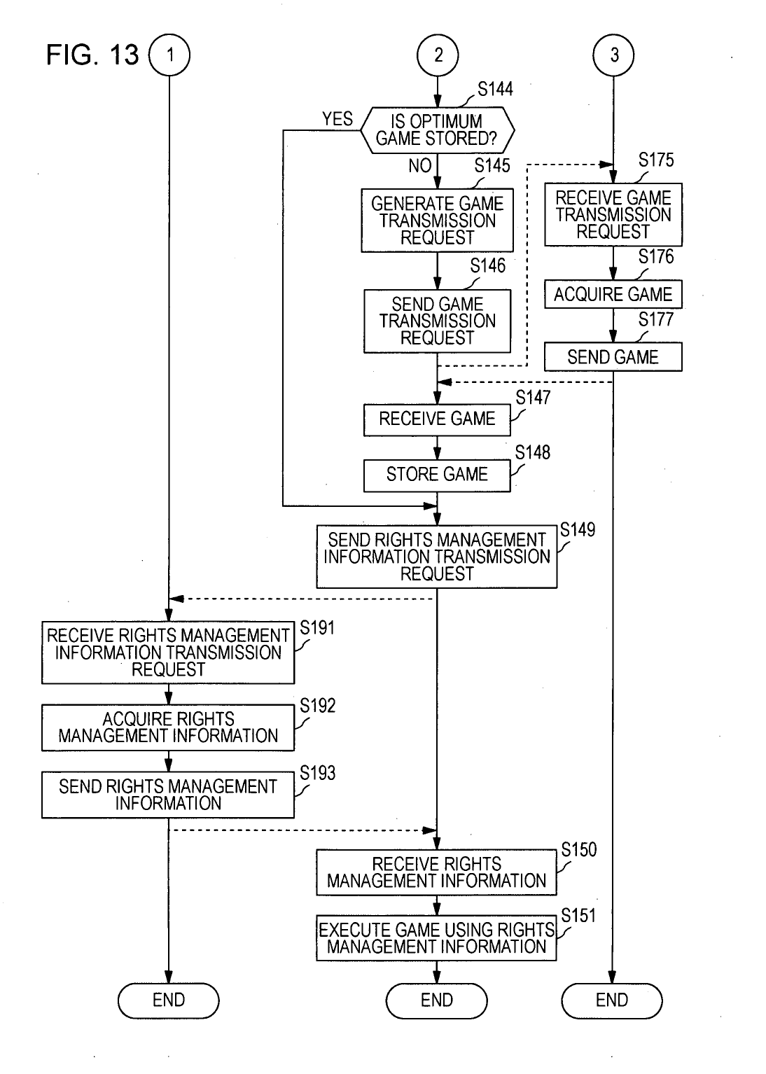

The acquiring means (for example, the communication unit 56 executing processing of STEP S150 in FIG. 13) acquires the rights management information read out from the read-only recording medium by a reading apparatus.

An information processing method, a program, or a recording medium according to the second aspect of the present invention includes the steps of acquiring rights management information managing the use of a predetermined content or predetermined software, from a read-only recording medium having stored therein the rights management information and not having stored therein the predetermined content or the predetermined software (for example, processing of STEP S20 in FIG. 3 or processing of STEP S80 in FIG. 8), and obtaining the predetermined content or the predetermined software and reproducing the predetermined content or executing the predetermined software, using the acquired rights management information (for example, processing of STEP S21 in FIG. 3 or processing of STEP S81 in FIG. 8).

In the following, the preferred embodiments of the present invention will be described with reference to the accompanying drawings.

FIG. 2 illustrates an example of a configuration of a distribution system according to an embodiment of the present invention. This distribution system includes a client apparatus 41 and a server apparatus 42. The client apparatus 41 is connected to the server apparatus 42 via a communication network 43 constituted by one or a plurality of networks such as the Internet and a home network.

A user, who owns the client apparatus 41, can use a content or software stored in the server apparatus 42 by obtaining a recording medium 44 through purchase or the like. In this recording medium 44, rights management information serving to manage the use of the content or software is stored.

For example, when the recording medium 44 purchased by the user is inserted into the client apparatus 41, the client apparatus 41 acquires the rights management information from the recording medium 44. Using the acquired rights management information, the client apparatus 41 reproduces the content or executes the software which is received from the server apparatus 42.

The recording medium 44 has stored therein server information for specifying the address of the server apparatus 42, a content identifier serving as information for specifying the content or software stored in the server apparatus 42, and the rights management information used for reproducing the content specified by the content identifier or execution of the software specified by the content identifier. In the example of FIG. 2, the recording medium 44 stores the content identifier of a predetermined game used as software and the content identifier of a moving image used as a content.

The recording medium 44 can be a read-only recording medium such as a CD-ROM, a DVD-ROM, and a BD-ROM (blue-ray disc-ROM).

The client apparatus 41 includes a control unit 51, a reading unit 52, a software executing unit 53, a content reproducing unit 54, a storage unit 55, a communication unit 56, an input unit 57, a display unit 58 and a bus 59. The control unit 51 to the display unit 58 are interconnected through the bus 59.

The control unit 51 controls the entire client apparatus 41. The reading unit 52 reads information including the server information, the content identifier, and the rights management information, from the recording medium 44 inserted into the client apparatus 41 and provides the read information to the individual components of the client apparatus 41.

The software executing unit 53 executes software received from the server apparatus 42 using the rights management information read from the recording medium 44. The content reproducing unit 54 reproduces a content received from the server apparatus 42 using the rights management information read from the recording medium 44.

The storage unit 55 includes a hard disk, for example, and stores various data, programs, or the like. The storage unit 55 also stores apparatus information indicating the type of software that can be executed in the client apparatus 41 and the type of content that can be executed by the client apparatus 41. In addition, the storage unit 55 is provided with a cache serving as a storage area for storing a content and software received from the server apparatus 42.

The communication unit 56 communicates with the server apparatus 42 via the communication network 43 so as to send and receive various data to and from the server apparatus 42. The input unit 57 includes a keyboard, a mouse, a controller, etc., for example, and sends the control unit 51 an instruction corresponding to a user operation. The display unit 58 includes a display such as a CRT (cathode ray tube) display and an LCD (liquid crystal display) and displays various images.

The server apparatus 42 includes a control unit 71, a database 72, a reading unit 73, and a communication unit 74.

The control unit 71 controls the entire server apparatus 42. The database 72 includes a hard disk or the like and stores information such as a content and software to be distributed to the client apparatus 41 and meta information associated with the content and the software.

For example, the database 72 stores a content such as a moving image, a still image, a music piece, and a text and software such as a game, an application program for displaying a program listing, and an application program for reproducing a music piece. This content and this software are prepared and stored for each type (specifications) of the client apparatus 41 which receives the distribution of the content and software. That is, the database 72 stores a plurality of content data whose content is the same and software data whose content is the same, so that that the content and software can be used by every type of the client apparatus 41.

In the example illustrated in FIG. 2, the database 72 stores a moving image serving as a content and a game serving as software. In addition, the database 72 also stores meta information about the moving image and meta information about the game. These pieces of meta information are associated with the stored moving image and the game, respectively.

In FIG. 2, the database 72 is included in the server apparatus 42. However, the database 72 can be a device independent of the server apparatus 42.

The reading unit 73 acquires data stored in the database 72 such as the content, the software or the associated meta information and sends the acquired data to the communication unit 74. The communication unit 74 communicates with the client apparatus 41 via the communication network 43 and sends and receives various data to and from the client apparatus 41. For example, the communication unit 74 sends the client apparatus 41 the content, the software, or the associated meta information via the communication network 43.

When a user inserts the recording medium 44 into the client apparatus 41 and instructs execution of a predetermined game serving as software by operating the input unit 57, the client apparatus 41 initiates game execution processing for executing the game designated by the user. When the server apparatus 42 receives a request for transmission of the predetermined game from the client apparatus 41, the server apparatus 42 initiates game transmission processing for transmitting the predetermined game.

In the following, referring to flowcharts shown in FIG. 3, procedures of the game execution processing performed by the client apparatus 41 and the game transmission processing performed by the server apparatus 42 will be described.

At STEP S11, the reading unit 52 acquires server information and a content identifier of the game from the recording medium 44 inserted into the client apparatus 41 and sends the acquired server information and content identifier to the control unit 51.

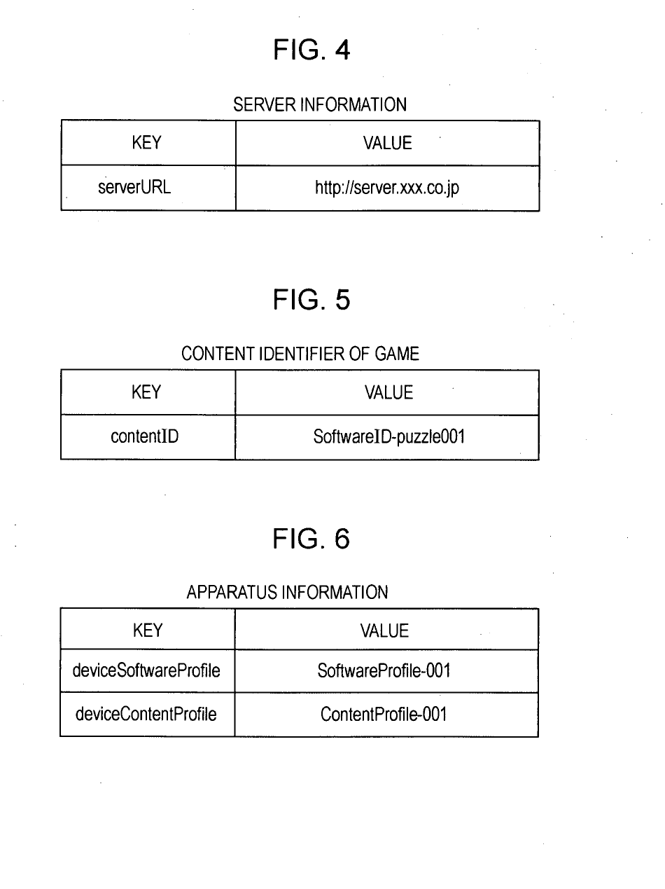

As shown in FIG. 4, the server information acquired by the reading unit 52 includes, for example, information specifying an address of the server apparatus 42 on the communication network 43. In the example of FIG. 4, the server information contains a key “serverURL (uniform resource locator)” and a corresponding value “http://server.xxx.co.jp/”, which represents the address of the server apparatus 42. The value “http://server.xxx.co.jp/” represents the address of the server apparatus 42 in the URL field. Hereinafter, the address of the server apparatus 42 will also be referred to as the URL of the server apparatus 42.

As shown in FIG. 5, the content identifier of the game includes information representing a content ID (identification) which specifies the game. In FIG. 5, the content identifier includes a key “contentID” and a corresponding value “SoftwareID-puzzle001”, which represents the content ID of the game.

Referring back to the flowchart of FIG. 3, when the server information and the game content identifier are sent from the reading unit 52 to the control unit 51, the control unit 51 acquires the apparatus information from the storage unit 55 and sends the communication unit 56 the acquired apparatus information, server information, and content identifier, at STEP S12.

For example, the control unit 51 acquires from the storage unit 55 the apparatus information illustrated in FIG. 6. In the example of FIG. 6, the apparatus information contains a device software profile representing a type of software that can be executed by the client apparatus 41 and a device content profile representing a type of content that can be reproduced by the client apparatus 41.

The apparatus information, as illustrated in FIG. 6, contains a key “deviceSoftwareProfile” and a corresponding value “SoftwareProfile-001”, which represents the type of software that can be executed by the client apparatus 41. The apparatus information also contains a key “deviceContentProfile” and a corresponding value “ContentProfile-001”, which represents the type of content that can be reproduced by the client apparatus 41. This device software profile and this device content profile are determined on the basis of the type of OS (operating system) that is executed by the client apparatus 41, the specifications of a controller serving as the input unit 57, a decryption scheme that can be used in the client apparatus 41, and the aspect ratio of the screen of the display unit 58.

Referring back to the flowcharts of FIG. 3, when the apparatus information, the server information, and the content identifier is sent from the control unit 51 to the communication unit 56, the communication unit 56 transmits the received game content identifier and the apparatus information to the server apparatus 42 which is specified by the server information, via the communication unit 43, at STEP S13.

At STEP S41, the communication unit 74 of the server apparatus 42 receives the game content identifier and the apparatus information transmitted from the client apparatus 41. The communication unit 74 then sends the received content identifier and the apparatus information to the control unit 71.

At STEP S42, on the basis of the content identifier and the apparatus information, the control unit 71 refers to meta information stored in the database 72 and searches for a game that is the most suitable for the type (specifications) of the client apparatus 41 (optimum game). Specifically, the control unit 71 selects a game from among games stored in the database 72, which is specified by the received content identifier and can be executed by the client apparatus 41.

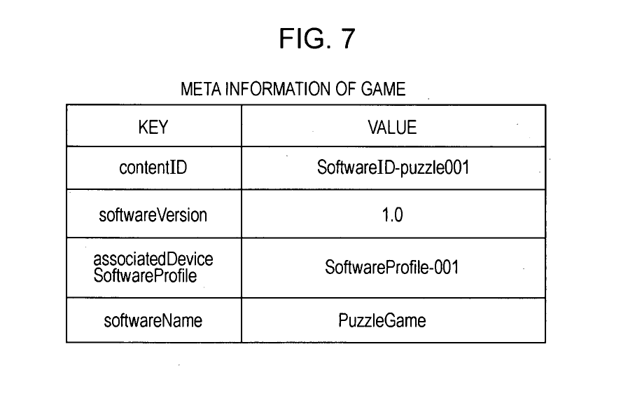

For example, the database 72 stores the meta information of the game, as illustrated in FIG. 7. The meta information of the game includes information such as a content ID specifying the game associated with the meta information, a software version that implements the game (i.e., a software version indicative of a version number of the game), a device software profile associated with the software version, and the name of the game associated with the meta information.

In the example of FIG. 7, the meta information contains a key “contentID” and a corresponding value “SoftwareID-puzzle001”, which represents the content ID, a key “softwareVersion” and a corresponding value “1.0”, which represents the version number of the game, a key “associatedDeviceSoftwareProfile” and a corresponding value “SoftwareProfile-001”, which represents the associated device profile, and a key “softwareName” and a corresponding value “PuzzleGame”, which represents the name of the game.

Thus, the game specified by the meta information illustrated in FIG. 7 is regarded as being executable by the client apparatus 41, which stores the apparatus information containing the device software profile “SoftwareProfile-001”. The software version indicative of the version number of the game can be updated to, for example, “2.0”, “3.0”, etc., every time the game is updated.

For example, when the control unit 71 receives the content identifier shown in FIG. 5 and the apparatus information shown in FIG. 6, the control unit 71 searches for the meta information that contains the content ID “SoftwareID-puzzle001” and the associated device software profile “SoftwareProfile-001”, among the meta information stored in the database 72, so as to find the optimum game.

Referring back to the flowcharts of FIG. 3, when the optimum game has been found, the reading unit 73 acquires the meta information associated with the found optimum game from the database 72 and sends the acquired meta information to the communication unit 74, on the basis of the control of the control unit 71, at STEP S43.

If a plurality of pieces of meta information has been found by the control unit 71, the reading unit 73 acquires the one among the plurality of pieces of meta information that contains the newest software version. It is also possible that all pieces of the found meta information are transmitted to the client apparatus 41 so that the client apparatus 41 selects a preferred software version.

At STEP S44, the communication unit 74 sends the client apparatus 41 the meta information sent by the reading unit 73 via the communication unit 43.

When the meta information is transmitted from the server apparatus 42 to the client apparatus 41, the communication unit 56 of the client apparatus 41 receives the meta information and sends the meta information to the control unit 51 at STEP S14.

For example, the control unit 51 determines that the optimum game is stored if a content or software that has been received from the server apparatus 42 or another apparatus is stored in the cache of the storage unit 55 and when the game specified by the received meta information corresponds to the cached content or software. On the other hand, for example, the control unit 51 determines that the optimum game is not recoded if the cached game has the same content ID as the content ID of the game specified by the meta information, but the cached game is of a software version older than that of the game specified by the meta information (i.e., the game specified by the meta information is of an updated version of the cached game).

If it is determined in STEP S15 that the optimum game is stored, indicating that the game specified by the meta information is already stored in the cache of the storage unit 55, processing of STEP S16 to STEP S19 will be skipped and the procedure proceeds to STEP S20.

On the other hand, if it is determined in STEP S15 that the optimum game is not stored, indicating that the game specified by the meta information is not stored in the cache of the storage unit 55, the procedure proceeds to STEP S16.

At STEP S16, the control unit 51 generates a transmission request for requesting transmission of the game specified by the received meta information and sends the generated game transmission request to the communication unit 56.

AT STEP S17, the communication unit 56 transmits the game transmission request received from the control unit 51, to the server apparatus 42 via the communication network 43.

When the game transmission request is transmitted from the client apparatus 41 to the server apparatus 42, the communication unit 74 of the server apparatus 42 receives the game transmission request transmitted from the client apparatus 41 and sends the received game transmission request to the control unit 71, at STEP S45.

At STEP S46, on the basis of the control of the control unit 71, the reading unit 73 acquires from the database 72 the game of which the transmission is requested by the received game transmission request and sends the acquired game to the communication unit 74. That is, the reading unit 73 acquires from the database 72 the game associated with the meta information that has been transmitted to the client apparatus 41.

At STEP S47, the communication unit 74 transmits the game sent from the reading unit 73 (to be more specific, software for implementing the game) to the client apparatus 41 via the communication network 43, and thus the game transmission processing is terminated.

When the game is transmitted from the server apparatus 42 to the client apparatus 41, the communication unit 56 receives the game from the server apparatus 42 and sends the received game to the control unit 51, at STEP S18. The control unit 51 sends the game provided by the communication unit 56 to the storage unit 55.

At STEP S19, the storage unit 55 stores the game provided by the control unit 51 in the cache of the storage unit 55.

When the received game is stored in STEP S19 or when it is determined in STEP S15 that the optimum game is stored, then at STEP S20, the reading unit 52 acquires from the recording medium 44 rights management information to be used for executing the game of which the execution is instructed by the user (i.e. the game specified by the content identifier obtained in the processing of STEP S11). The reading unit 52 sends the acquired rights management information to the software executing unit 53.

When receiving the rights management information from the reading unit 52, the software executing unit 53 acquires from the cache of the storage unit 55 the game of which the execution is instructed.

At STEP S21, the software executing unit 53 executes the game acquires from the storage unit 55, using the rights management information sent from the reading unit 52, and thus the game execution processing is terminated.

For example, the game serving as software stored in the cache of the storage unit 55 (i.e., the game stored in the database 72 of the server apparatus 42) has been encrypted using an encryption technique such as RSA (Rivest Shamir Adleman) and DES (Data Encryption Standard). The rights management information stored in the recording medium 44 contains a key for decrypting the game.

The software executing unit 53 decrypts the game using the key contained in the rights management information by a decryption technique corresponding to the encryption technique applied to the game. Then, the software executing unit 53 executes the decrypted game. When the game is executed, the display unit 58 displays a screen for the game, and the software executing unit 53 performs processing in accordance with an operation performed by the user using the input unit 57.

Thus, as described above, the server apparatus 42 selects the game that can be executed by the client apparatus 41 from among the stored games and transmits the game to the client apparatus 41. The client apparatus 41 uses the rights management information acquired from the recording medium 44 so as to execute the game stored in the storage unit 55 or the game transmitted by the server apparatus 42.

Thus, this arrangement, in which a game serving as software are stored in the server apparatus 42, allows the server apparatus 42 to readily update software such as the stored games and provide software of the newest version to the client apparatus 41.

In addition, the server apparatus 42 stores pieces of software of different software versions and pieces of meta information associated with the individual pieces of software. This allows the client apparatus 41 to readily select a piece of software of a version executable by the client apparatus 41 to transmit the selected software to the client apparatus 41. Thus, by storing-software of different versions, simple and low-cost management of software to be provided to the client apparatus 41 can be realized.

Further, since the client apparatus 41 receives desired software such as a game, the client apparatus 41 can readily acquire executable software that is of the newest version and can execute the acquired software without updating the software every time the version of the software is updated.

When the user inserts the recording medium 44 into the client apparatus 41 and instructs reproduction of a predetermined moving image which serves as a content, by operating the input unit 57, the client apparatus 41 initiates moving image reproduction processing to reproduce the moving image, similarly to the case where the user instructs the execution of the game described above. When the client apparatus 41 requests the server apparatus 42 for transmission of a predetermined moving image, the server apparatus 42 initiates moving image transmission processing for transmitting the moving image.

Referring to flowcharts in FIG. 8, procedures of the moving image reproduction processing performed by the client apparatus 41 and the moving image transmission processing performed by the server apparatus 42 will be described.

At STEP S71, the reading unit 52 acquires server information and a content identifier of a moving image from the recording medium 44 inserted into the client apparatus 41 and sends the acquired server information and content identifier to the control unit 51.

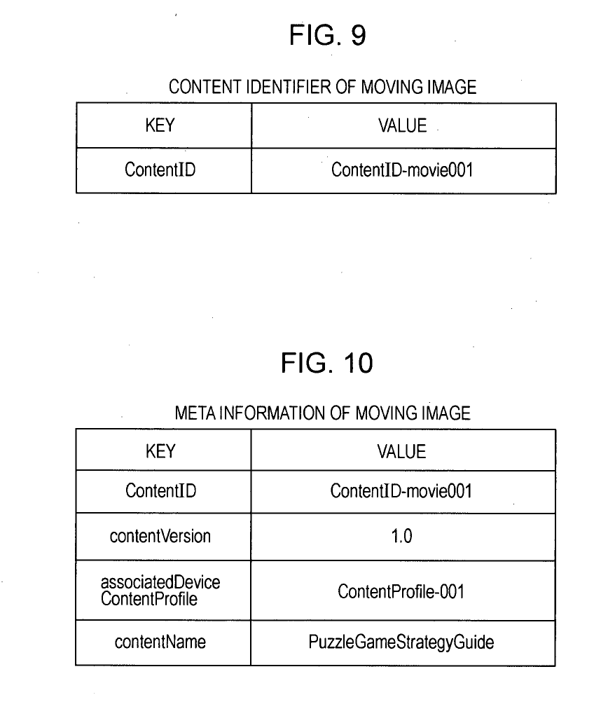

The content identifier of the moving image acquired by the reading unit 52 includes, for example, information indicative of a content ID that specifies the moving image, as shown in FIG. 9. In the example of FIG. 9, the content identifier of the moving image contains a key “contentID” and a corresponding value “ContentID-movie001”, which represents the content ID of the moving image.

Referring back to the flowcharts of FIG. 8, when the server information and the moving image content identifier is sent from the reading unit 52, the control unit 51 acquires apparatus information from the storage unit 55 and sends the acquired apparatus information, server information, and content identifier to the communication unit 56, at STEP S72. At STEP S73, the communication unit 56 transmits the received moving image content identifier and apparatus information via the communication network 43 to the server apparatus 42 that is specified by the server information.

At STEP S101, the communication unit 74 of the server apparatus 42 receives the moving image content identifier and apparatus information transmitted from the client apparatus 41 and sends the received content identifier and apparatus information to the control unit 71.

At STEP S102, the control unit 71 refers to the meta information stored in the database 72 on the basis of the content identifier and apparatus information so as to search for a moving image that is the most suitable for the specifications of the client apparatus 41 (optimum moving image). Specifically, the control unit 71 searches for, from among moving images stored in the database 72, the moving image that is specified by the received content identifier and can be reproduced by the client apparatus 41.

For example, meta information about the moving image is stored in the database 72, as illustrated in FIG. 10, for example. As shown in the figure, the meta information contains information indicating a content ID for specifying a moving image associated with the meta information, a version of the moving image (i.e., a content version indicative of the version number of the moving image), a device content profile associated with the content version, and the name of the moving image associated with the meta information.

In the example of FIG. 10, the meta information contains a key “contentID” and a corresponding value “ContentID-movie001”, which represents the content ID, a key “contentVersion” and a corresponding value “1.0”, which represents the version number of the moving image, a key “associatedDeviceContentProfile” and a corresponding value “ContentProfile-001”, which represents the device content profile, and a key “contentName” and a corresponding value “PuzzleGameStrategyGuide”, which represents the name of the moving image.

Thus, the moving image specified by the meta information illustrated in FIG. 10 can be such a moving image that can be reproduced by the client apparatus 41 storing the apparatus information that contains the device content profile “ContentProfile-001”.

For example, when the content identifier illustrated in FIG. 9 and the apparatus information illustrated in FIG. 6 are transmitted to the control unit 71, the control unit 71 searches for the optimum moving image by searching for, among the meta information stored in the database 72, the meta information that includes the content ID “ContentID-movie001” and the associated device content profile “ContentProfile-001”.

Referring back to the flowcharts of FIG. 8, when the optimum moving image is found, the reading unit 73 acquires from the database 72 the meta information associated with the found moving image and sends the meta information to the communication unit 74, at STEP S103. At STEP S104, the communication unit 74 transmits the meta information received from the reading unit 73, to the client apparatus 41 via the communication network 43.

When the meta information is transmitted from the server apparatus 42 to the client apparatus 41, the communication unit 56 of the client apparatus 41 receives the meta information from the server apparatus 42 and sends the meta information to the control unit 51, at STEP S74. At STEP S75, the control unit 51 refers to the meta information sent from the communication unit 56 and determines whether or not the optimum moving image is stored in a cache in the storage unit 55.

If it is determined in STEP S75 that the optimum moving image is stored, indicating that the moving image specified by the meta information is already stored in the cache of the storage unit 55, processing of STEP S76 to STEP S79 will be skipped, and the procedure proceeds to STEP S80.

On the other hand, if it is determined in STEP S75 that the optimum moving image is not stored, indicating that the moving image specified by the meta information is not stored in the cache of the storage unit 55, the procedure proceeds to STEP S76.

At STEP S76, the control unit 51 generates a transmission request for requesting transmission of the moving image specified by the received meta information and sends the generated transmission request to the communication unit 56. At STEP S77, the communication unit 56 sends the server apparatus 42 the moving image transmission request received from the control unit 51 via the communication network 43.

When the moving image transmission request is transmitted from the client apparatus 41 to the server apparatus 42, the communication unit 74 of the server apparatus 42 receives the transmission request from the client apparatus 41 and sends the received transmission request to the control unit 71, at STEP S105. On the basis of the control of the control unit 71, the reading unit 73 acquires from the database 72 the moving image of which the transmission is requested by the received transmission request and provides the acquired moving image to the communication unit 74, at STEP S107. That is, the reading unit 73 acquires from the database 72 the moving image associated with the meta information that has been sent to the client apparatus 41.

At STEP S107, the communication unit 74 transmits the moving image provided by the reading unit 73 (to be more specific, the moving image data for reproducing the moving image) to the client apparatus 41 via the communication network 43, and then the moving image transmission processing is terminated.

When the moving image is transmitted from the server apparatus 42 to the client apparatus 41, the communication unit 56 receives the moving image from the server apparatus 42 and sends the received moving image to the control unit 51, at STEP S78. The control unit 51 sends the moving image to the storage unit 55.

At STEP S79, the storage unit 55 stores the moving image sent from the control unit 51 in the cache.

When the moving image is stored in STEP S79, or when it is determined in STEP S75 that the optimum moving image is already stored, the reading unit 52 acquires from the recording medium 44 the rights management information, at STEP S80. This rights management information is used for reproducing the moving image of which the reproduction is instructed by the user (i.e., the moving image specified by the content identifier acquired in the processing of STEP S71). The reading unit 52 provides the acquired rights management information to the content reproducing unit 54.

When the rights management information is provided from the reading unit 52 to the content reproducing unit 54, the content reproducing unit 54 acquires the moving image from the cache of the storage unit 55. At STEP S81, the content reproducing unit 54 reproduces the moving image acquired from the storage unit 55, using the rights management information provided by reading unit 52, and thus the moving image reproduction processing is terminated.

For example, the moving image serving as a content stored in the cache of the storage unit 55, (i.e., the moving image stored in the database 72 of the server apparatus 42) has been encrypted through an encryption technique such as RSA and DES. The content reproducing unit 54 uses a key contained in the rights management information so as to decrypt the moving image using a decryption technique corresponding to the encryption technique applied to the moving image and thus reproduce the decrypted moving image. Thus, the reproduced moving image is displayed on the display unit 58.

As described above, in accordance with the request from the client apparatus 41, the server apparatus 42 selects from among stored moving images a moving image that can be reproduced by the client apparatus 41 and transmits the moving image to the client apparatus 41. The client apparatus 41 reproduces the moving image stored in the storage unit 55 or the moving image transmitted from the server apparatus 42, using rights management information acquired from the recording medium 44.

Thus, this arrangement, in which the moving images serving as contents are stored in the server apparatus 42, allows the server apparatus 42 to readily update stored contents such as the moving images and provide a content of the newest version to the client apparatus 41.

In addition, as described above, the server apparatus 42 stores contents having different versions and pieces of meta information associated with the individual contents. This arrangement allows the server apparatus 42 to readily select a content of a version that can be reproduced by the client apparatus 41 and provide the selected content to the client apparatus 41. Thus, by storing the contents having different versions in the server apparatus 42, simple and low-cost management of contents to be provided to the client apparatus 41 can be realized.

Further, since the client apparatus 41 receives a desired content such as a moving image from the server apparatus 42, the client apparatus 41 can always readily acquire a content that is of the newest version and can be reproduced by itself, without keeping the content updated every time the content is updated.

When a content or software stored in the database 72 is updated, the content or software of the new version is added to the database 72 and meta information associated with the newly added content or software is also stored. The content version or software version contained in the meta information is regarded as being the newest content version or the newest software version.

It can also be configured such that a content or software and corresponding meta information are stored in advance in the recording medium 44, so that the control unit 51 refers to the stored meta information to determine whether or not the optimum moving image or game is stored in the recording medium 44, in the processing of STEP S15 in FIG. 3 or STEP S75 in FIG. 8 described above.

In this case, if it is determined that the optimum game or moving image is stored in the recording medium 44, the client apparatus 41 acquires from the recording medium 44 the game or moving image designated by the user and executes the game or executes the moving image. Further, it is also possible that the game or moving image acquired from the recording medium 44 is stored in the cache of the storage unit 55.

Thus, this arrangement, in which a content or software is stored in the recording medium 44, allows the client apparatus 41 to reproduce the content stored in the 44 or execute the software stored in the recording medium 44, even in a case where the client apparatus 41 is not able to communicate with the server apparatus 42. In addition, by storing the content or software acquire from the recording medium 44 in the cache of the storage unit 55, the client apparatus 41 can immediately reproduce the content or execute the software designated by the user if the client apparatus 41 has stored therein the content or software.

Moreover, in the distribution system illustrated in FIG. 2, the client apparatus 41 receives a content or software from the server apparatus 42. However, it is also possible to store in advance a part of a content or software which is not to be updated or a part of a content or software which can be commonly used among a plurality of client apparatuses 41. In this case the client apparatus 41 acquires the rest part of the content or software (i.e., a part not stored in the recording medium 44) from the server apparatus 42.

With this arrangement, for example, when the client apparatus 41 executes the part of the game stored in the recording medium 44, only one user will participate in the executed game. However, when the client apparatus 41 receives the rest part of the game from the server apparatus 42, a plurality of users can participate in the game.

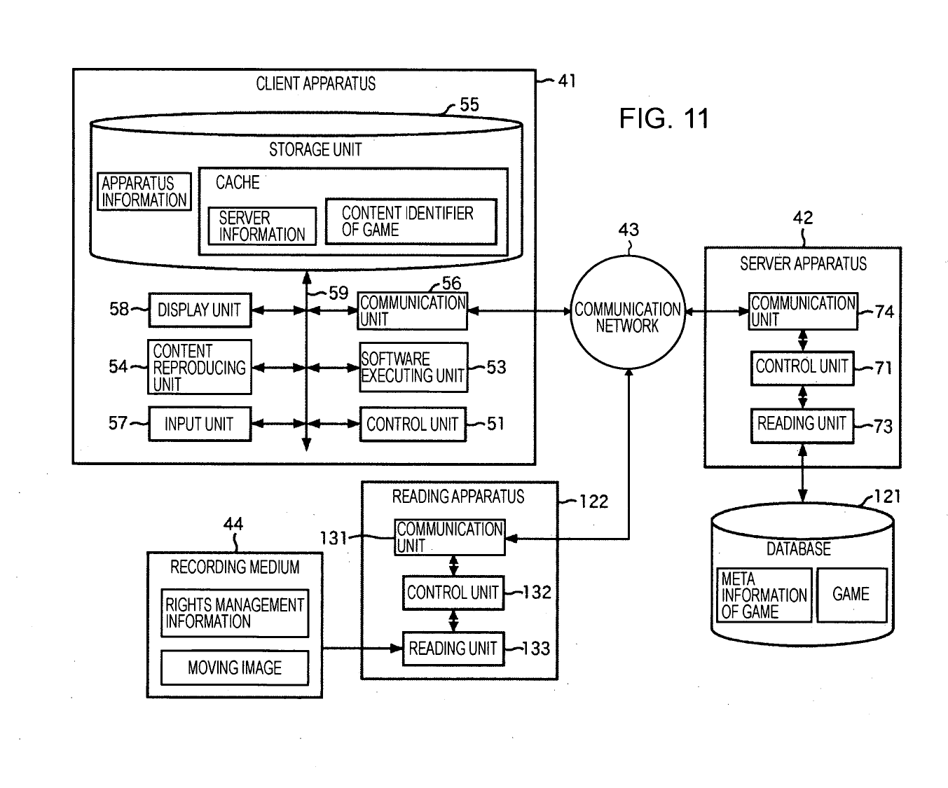

In the foregoing, it is described that a content and software are stored in the server apparatus 42, and rights management information used for using the content and software is stored in the recording medium 44. However, it can also be configured such that the rights management information is acquired from a reading apparatus 122 connected to the client apparatus 41, as illustrated in FIG. 11.

Referring to FIG. 11, a distribution system according to an embodiment of the present invention is illustrated. In this system, the client apparatus 41 is further connected to the reading apparatus 122 via the communication network 43. This reading apparatus 122 can be a reproducing apparatus such as a CD player, a DVD player, and a BD player, for reading and reproducing data stored in a read-only recording medium such as a CD-ROM, a DVD-ROM, and a BD-ROM. A database 121 storing a content or software is connected to the server apparatus 42. In FIG. 11, components which are the same as or correspond to those in FIG. 2 are designated by the same reference numerals, and the description thereof will be omitted as necessary.

The storage unit 55 of the client apparatus 41 in the system of FIG. 11 is provided with a cache serving as a storage area for storing a content or software. In this cache, server information and a content identifier are stored as well as a content or software. In the example of FIG. 11, the cache of the storage unit 55 stores server information and a content identifier of a game.

The database 121 is connected to a server apparatus 42, so that a reading unit 73 of the server apparatus 42 acquires a content, software, or meta information from the database 121. In the database 121 of FIG. 11, a game serving as software and meta information of the game that is associated with the game are stored. In FIG. 11, it can be seen that the database 121 is directly connected to the server apparatus 42. However, the database 121 can also be connected to the server apparatus 42 via the communication network 43.

The client apparatus 41 is connected to the reading apparatus 122 via the communication network 43 such as a home network. The recording medium 44, in which information such as a content, software, and rights management information is stored, is inserted into the reading apparatus 122. In the example of FIG. 11, the recording medium 44 stores rights management information and a moving image serving as a content.

The reading apparatus 122 includes a communication unit 131, a control unit 132, and a reading unit 133.

The communication unit 131 communicates with the client apparatus 41 via the communication network 43 so as to send and receive various data to and from the client apparatus 41. The control unit 132 controls the entire reading apparatus 122. The reading unit 133 reads out a content, software, or rights management information from the recording medium 44 inserted into the reading apparatus 122.

As described above, the recording medium 44 stores the rights management information. This rights management information is used for executing the game stored in the database 121. When a user uses the game stored in the database 121, the user obtains the recording medium 44 in advance in which the rights management information for the desired game through purchase or the like.

Then, the user operates the client apparatus 41 to activate a web browser or the like, so that the client apparatus 41 receives from a server or the like connected to the communication network 43 the content identifier of the game and server information that specifies the server apparatus 42 from which the game will be provided. The received game content identifier and the server information are stored in the cache of the storage unit 55.

When the user inserts the recording medium 44 into the reading apparatus 122 and operates an input unit 57 of the client apparatus 41 to instruct execution of the game specified by the content identifier stored in the cache of the storage unit 55, the client apparatus 41 initiates game execution processing for executing the game designated by the user.

Then, the client apparatus 41 requests the server apparatus 42 for transmission of a predetermined game. In response to the game transmission request, the server apparatus 42 initiates game transmission processing for transmitting the designated game. When the client apparatus 41 requests the reading apparatus 122 for transmission of rights management information, the reading apparatus 122 initiates transmission processing for transmitting the requested rights management information.

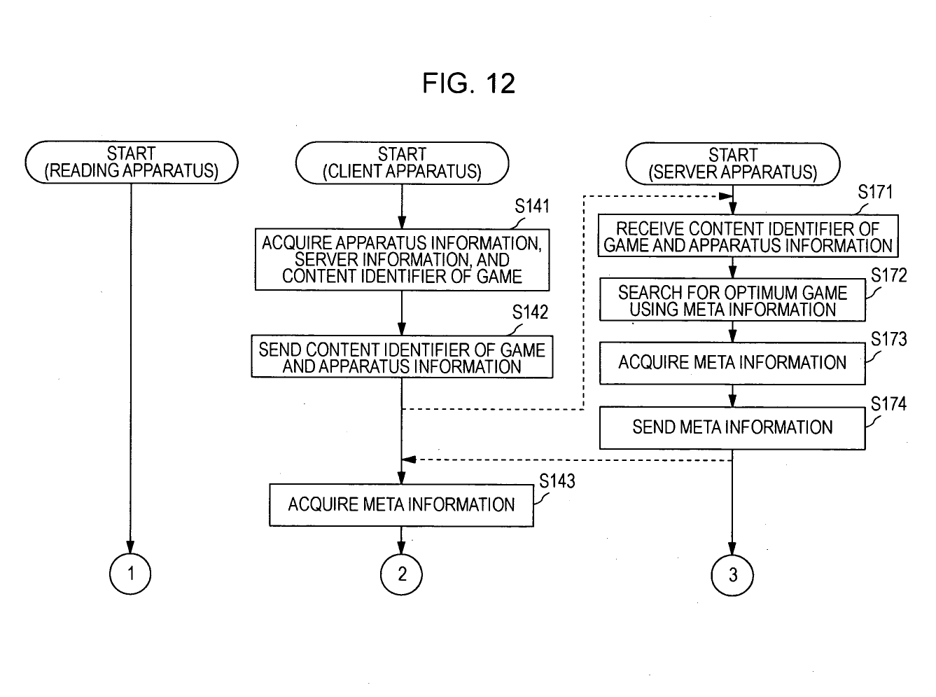

In the following, referring to flowcharts in FIG. 12 and FIG. 13, procedures of the game execution processing performed by the client apparatus 41, the game transmission processing performed by the server apparatus 42, and the rights management information transmission processing performed by the reading apparatus 122 will be described.

At STEP S141, the control unit 51 of the client apparatus 41 acquires data such as the apparatus information, the server information, and the game content identifier from the storage unit 55 and provides the acquired data to the communication unit 56.

At STEP S142, the communication unit 56 transmits the game content identifier and the apparatus information provided by the control unit 51, to the server apparatus 42 specified by the server information via the communication network 43.

When the content identifier and the apparatus information are transmitted from the client apparatus 41 to the server apparatus 42, the server apparatus 52 performs processing of STEP S171 to STEP S174. These processing steps are similar to the processing of STEP S41 to STEP S44 described with reference to FIG. 3, and thus the description thereof will be omitted.

At STEP S172, the control unit 71 of the server apparatus 42 refers to the meta information stored in the database 121 connected to the server apparatus 42 so as to search for a game that is the most suitable for the type (specifications) of the client apparatus 41 (optimum game). At STEP S173, the reading unit 73 acquires the meta information stored in the database 121.

When the meta information is transmitted from the server apparatus 42 to the client apparatus 41 at STEP S174, the client apparatus 41 performs processing of STEP S143 to STEP S148. These processing steps are similar to the processing of STEP S14 to STEP S19 described with reference to FIG. 3, and the thus the description there of will be omitted.

When the game transmission request is transmitted from the client apparatus 41 to the server apparatus 42 at STEP S146, the server apparatus 42 performs processing of STEP S175 to STEP S177′. These processing steps are similar to the processing of STEP S45 to STEP S47, and thus the description thereof will be omitted. At STEP S176, the reading unit 73 acquires the game from the database 121 connected to the server apparatus 42.

When the received game is stored in STEP S148 or if it is determined in STEP S144 that the optimum game is stored, the control unit 51 generates a request for transmission of rights management information used for execution of the game designated by the user and sends the generated transmission request to the communication unit 56.

At STEP S149, the communication unit 56 transmits the transmission request received from the control unit 51, to the reading apparatus 122 via the communication network 43.

When the transmission request is transmitted from the client apparatus 41 to the reading apparatus 122, the communication unit 131 of the reading apparatus 122 receives the transmission request from the client apparatus 41 and provides the received transmission request to the control unit 132, at STEP S191.

At STEP S192, on the basis of the control of the control unit 132, the reading unit 133 acquires the rights management information of which the transmission is requested, from the recording medium 44 inserted into the reading apparatus 122. Then the reading unit 133 sends the acquired rights management information to the communication unit 131 via the control unit 132.

Then, at STEP S193, the communication unit 131 transmits the rights management information received from the reading unit 133 to the client apparatus 41 via the communication network 43, and thus the rights management information transmission processing is terminated.

When the rights management information is transmitted from the reading apparatus 122 to the client apparatus 41, the communication unit 56 of the client apparatus 41 receives the transmitted rights management information and sends the rights management information to the software executing unit 53, at STEP S150. When receiving the rights management information from the communication unit 56, the software executing unit 53 acquires the game of which the execution is instructed from the cache of the storage unit 55.

At STEP S151, the software executing unit 53 executes the game acquired from the storage unit 55, using the rights management information, and thus the game execution processing is terminated.

For example, the game serving as software which is stored in the cache of the storage unit 55 has been encrypted through an encryption technique such as RSA and DES. The software executing unit 53 uses a key contained in the rights management information so as to decrypt the game using a decryption technique corresponding to the encryption technique applied to the game and thus execute the decrypted game.

Thus, the client apparatus 41 acquires the rights management information from the reading apparatus 122 and executes the game received from the server apparatus 42, using the acquired rights management information.

Thus, rights management information is acquired from the reading apparatus 122 and a game is executed using the acquired rights management information. With this arrangement, even if the client apparatus 41 is not capable of reading data directly from the recording medium 44, the client apparatus 41 can acquire the rights management information stored in the recording medium 44 so as to execute the game.

In the foregoing, the case is described using the flowcharts of FIG. 12 and FIG. 13 where a game serving as software is received from the database 121 so as to be executed. However, in a case where a content is received from the database 121 so as to be reproduced, processing similar to that described with reference to the flowcharts of FIG. 12 and FIG. 13 will be performed.

As described above, the recording medium 44 illustrated in FIG. 11 stores the moving image serving as a content. This moving image is associated with, for example, a game stored in the database 121. The moving image can be reproduced using rights management information stored in the recording medium 44 and used for executing the game.

For example, when the moving image stored in the recording medium 44 is such a moving image demonstrating a strategy for the game stored in the data base 121, the game stored in the database 121 and the moving image stored in the recording medium 44 are associated with each other so that the game can be executed and the moving image can be reproduced using the same rights management information. This arrangement facilitates management of rights management information for contents and software.

When the game stored in the database 121 and the moving image stored in the recording medium 44 are associated with each other, as described above, the client apparatus 41 initiates moving image reproduction processing for acquiring the moving image using the reading apparatus 122 and reproducing the moving image. This moving image reproduction processing is performed when a user instructs reproduction of the moving image stored in the recording medium 44. When the client apparatus 41 requests the reading apparatus 122 for transmission of the moving image, the reading apparatus 122 initiates moving image transmission processing for transmitting the moving image.

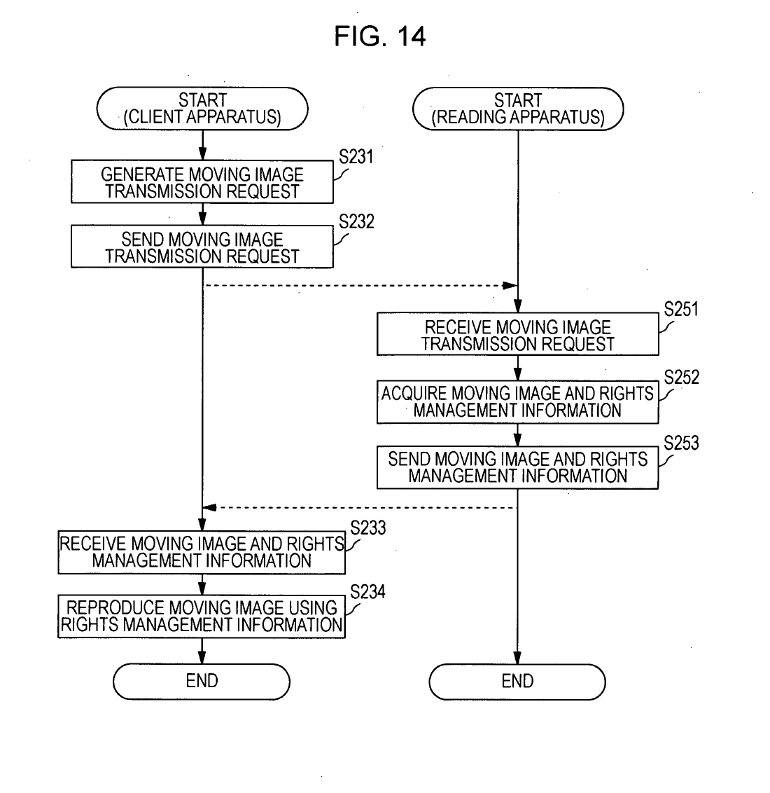

Referring now to flowcharts in FIG. 14, procedures of the moving image reproduction processing performed by the client apparatus 41 and the moving image transmission processing performed by the reading apparatus 122 will be described.

At STEP S231, the control unit 51 of the client apparatus 41 generates a moving image transmission request for requesting transmission of the moving image designated by the user and sends the generated request to the communication unit 56. At STEP S232, the communication unit 56 transmits the moving image transmission request to the reading apparatus 122 via the communication network 43.

When the transmission request is transmitted from the client apparatus 41 to the reading apparatus 122, the communication unit 131 of the reading apparatus 122 receives the transmission request from the client apparatus 41 and sends the transmission request to the control unit 132, at STEP S251.

At STEP S252, on the basis of the control of the control unit 132, the reading unit 133 acquires from the recording medium 44 inserted into the reading apparatus 122 the moving image of which the transmission is requested by the transmission request and the rights management information used for reproducing the moving image. The reading unit 133 sends the acquired moving image and rights management information to the communication unit 131 via the control unit 132.

At STEP S253, the communication unit 131 transmits the moving image and rights management information received from the reading unit 133, to the client apparatus 41 via the communication network 43, and thus the moving image transmission processing is terminated.

When the moving image and rights management information are transmitted from the reading apparatus 122 to the client apparatus 41, the communication unit 56 of the client apparatus 41 receives the moving image and rights management information transmitted from the reading apparatus 122 and sends the received moving image and rights management information to the content reproducing unit 54, at STEP S233.

At STEP S234, the content reproducing unit 54 reproduces the moving image using the rights management information, and thus the moving image reproduction processing is terminated.

For example, the moving image serving as a content received from the reading apparatus 122 has been encrypted through an encryption technique such as RSA and DES. The content reproducing unit 54 uses a key contained in the rights management information so as to decrypts the moving image using a decryption technique corresponding to the encryption technique applied to the moving image and thus reproduce the decrypted moving image. Thus, the reproduced moving image is displayed on the display unit 58.

Through these procedures described above, the client apparatus 41 acquires the moving image and rights management information from the reading apparatus 122 and reproduces the moving image using the rights management information.

Thus, a moving image associated with software stored in the database 121 is acquired from the reading apparatus 122 and reproduced as a content by using rights management information used for executing the associated software. With this arrangement, a plurality of pieces of software and associated contents can be executed or reproduced using the same rights management information. This facilitates the management of the rights management information used for executing the software and reproducing the contents.

In addition, it can also be configured such that a content or software is stored in the recording medium 44 in advance, and the content or software is reproduced or executed using rights management information stored in a recording medium other than the recording medium 44.

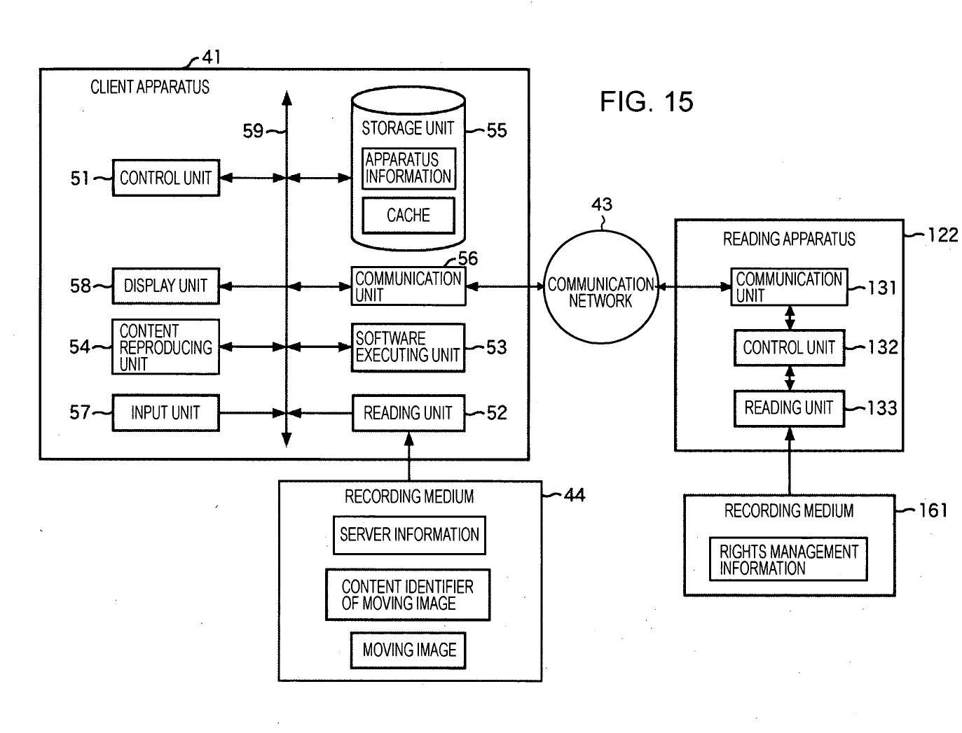

In such a case, the client apparatus 41 acquires the content or software from the recording medium 44 and further acquires rights management information using the reading apparatus 122 connected to the client apparatus 41 via the communication network 43, as illustrated in FIG. 15. In FIG. 15, components which are the same as or correspond to those in FIG. 2 and FIG. 11 are designated by the same reference numerals, and the description thereof will be omitted as necessary.

In a distribution system illustrated in FIG. 15, the client apparatus 41 is connected to the reading apparatus 122 through the communication network 43 constituted by a home network, for example.

The recording medium 44 to be inserted to the client apparatus 41 has stored therein server information, a content identifier, and a moving image serving as a content. For example, the moving image stored in the recording medium 44 can be a moving image such as a bonus video image associated with a moving image specified by the a moving image content identifier stored in the recording medium 44. This bonus video image is intended to be viewed only by a user who owns a recording medium 161 which is different from the recording medium 44.

The recording medium 161 can be a read-only recording medium such as a CD-ROM, a DVD-ROM, and a BD-ROM and inserted into the reading apparatus 122. The recording medium 161 stores rights management information used for reproducing the moving image stored in the recording medium 44.

For example, when the user instructs reproduction of the moving image specified by the moving image content identifier stored in the recording medium 44 by operating the client apparatus 41, the client apparatus 41 receives the moving image of which the reproduction is instructed, from the server apparatus 42 specified by the server information stored in the recording medium 44 and reproduces the received moving image, as described with reference to FIG. 8.

To view the moving image stored in the in the recording medium 44, which is associated with the moving image specified by the content identifier stored in the recording medium 44, the user first obtains the recording medium 161 through purchase or the like which stores the rights management information for reproducing the desired moving image. Then, the user inserts the recording medium 161 into the reading apparatus 122 and instructs the reproduction of the moving image.

When the reproduction of the moving image is instructed, the client apparatus 41 initiates moving image reproduction processing for reproducing the moving image designated by the user. Then, the client apparatus 41 requests the reading apparatus 122 for transmission of the rights management information. In response to the transmission request, the reading apparatus 122 initiates transmission processing for transmitting the rights management information.

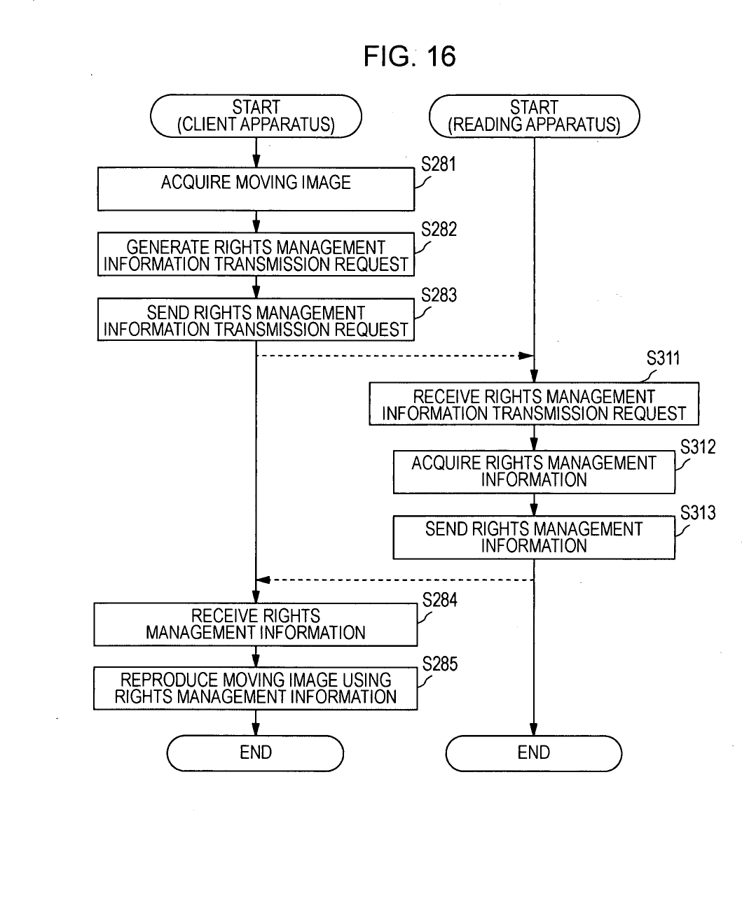

Referring now to flowcharts in FIG. 16, procedures of the moving image reproduction processing performed by the client apparatus 41 and the rights management information transmission processing performed by the reading apparatus 122 will be described.

At STEP S281, the reading unit 52 of the client apparatus 41 acquires the moving image of which the reproduction is instructed, from the recording medium 44 inserted into the client apparatus 41 and sends the acquired moving image to the content reproducing unit 54.

At STEP S282, the control unit 51 generates a transmission request for requesting transmission of the rights management information used for reproducing the designated moving image and sends the generated transmission request to the communication unit 56. At STEP S283, the communication unit 56 transmits the rights management information transmission request received from the control unit 51, to the reading apparatus 122 via the communication network 43. In this case, it is also possible that the user operates the client apparatus 41 to designate the reading apparatus 122 having the recording medium 161 inserted thereinto as a source of the rights management information.

When the transmission request is transmitted from the client apparatus 41 to the reading apparatus 122, the communication unit 131 of the reading apparatus 122 receives the rights management information transmission request from the client apparatus 41 and sends the received transmission request to the control unit 132, at STEP S311.

At STEP S312, on the basis of the control of the control unit 132, the reading unit 133 acquires the rights management information of which the transmission is requested by the transmission request, from the recording medium 161 inserted into the reading apparatus 122, at STEP S312.

At STEP S313, the communication unit 131 sends the rights management information received from the reading unit 133, to the client apparatus 41 via the communication network 43, and thus the rights management information transmission processing is terminated.

When the rights management information is transmitted from the reading apparatus 122 to the client apparatus 41, the communication unit 56 of the client apparatus 41 receives the rights management information from the reading apparatus 122 and sends the received rights management information to the content reproducing unit 54, at STEP S284.

At STEP S285, the content reproducing unit 54 reproduces the moving image acquired from the recording medium 44 using the rights management information received from the communication unit 56, and thus the moving image reproduction processing is terminated.

For example, the moving image serving as a content acquired from the recording medium 44 has been encrypted through an encryption technique such as RSA and DES. The content reproducing unit 54 uses a key contained in the rights management information so as to decrypt the moving image using a decryption technique corresponding to the encryption technique applied to the moving image and thus reproduce the decrypted moving image. Thus, the reproduced moving image is displayed on the display unit 58.

Thus, the client apparatus 41 acquires the rights management information from the reading apparatus 122 and reproduces the moving image stored in the recording medium 44 using the acquired rights management information.

With this arrangement, in which reproduction of a content stored in the recording medium 44 is managed using rights management information stored in the recording medium 161, reproduction of contents and execution of software can be managed with increased flexibility.

In the distribution system illustrated in FIG. 15, the client apparatus 41 acquires from the reading apparatus 122 rights management information stored in the recording medium 161. However, it can also be configured such that the client apparatus 41 acquires the rights management information from the server apparatus 42 connected to the client apparatus 41 via the communication network 43. In this case, the server apparatus 42 reads out the rights management information from the recording medium 161 and transmits the read rights management information to the client apparatus 41.

As described above, rights management information stored in a read-only recording medium is used for reproducing or executing a content or software stored in another recording medium or another apparatus. This arrangement facilitates reproduction of desired contents and execution of desired software.

In addition, it is also possible that information such as the amount of current traffic on the communication network 43 and the processing capability of the client apparatus 41 is included in the apparatus information to be transmitted from the client apparatus 41 to the server apparatus 42, so that the optimum content or the optimum software to be transmitted from the server apparatus 42 to the client apparatus 41 can be changed dynamically.

The information on the processing capability of the client apparatus 41 can be the percentage utilization of a CPU (Central Processing Unit) or a memory which constitutes the client apparatus 41 and the amount of an available space in the storage area of the storage unit 55. Thus, the apparatus information contains information such as the usage status of the communication network 43 and the processing capability of the client apparatus 41. With this information, the server apparatus 42 can select a content or software according to the received apparatus information from among contents having different image resolutions or pieces of software having different numbers of game participants and send the selected content or software to the client apparatus 41.

Further, it is also possible that the apparatus information contains information indicative of the model of the client apparatus 41 or the like. With this information, the server apparatus 42 can select a content or software having appropriate visual quality for the model of the client apparatus 41 and send the selected content or software to the client apparatus 41.

In the foregoing, the server information contains information representing the URL of the server apparatus 42. However, it is also possible that a search apparatus for searching for the URL of the server apparatus 42 can be connected to the communication network 43.

In this case, the client apparatus 41 acquires from the recording medium 44 a server identifier for specifying the client apparatus 42, which indicates the name of the server apparatus 42 or the like. Then the client apparatus 41 transmits the server identifier to the search apparatus. The search apparatus receives the server identifier transmitted from the client apparatus 41 and searches for the URL of the server apparatus 42 specified by the server identifier. The search apparatus then transmits the URL of the server apparatus 42 acquired as a result of the search operation, to the client apparatus 41. Then client apparatus 41 transmits apparatus information and a content identifier to the destination designated by the URL of the server apparatus 42 received from the search apparatus.

Moreover, it can also be configured such that a plurality of pieces of rights management information are used to reproduce one content. Thus, only a user who has purchased a plurality of contents (i.e., a plurality of recording media 44) can view a predetermined content serving as a privilege that can be reproduced using the plurality of pieces rights management information stored in the recording media 44.

It is also possible that the client apparatus 41 receives not only software to be executed in the client apparatus 41 but also software which can be executed in another apparatus such as a mobile phone, by using the rights management information stored in the recording medium 44.

The processing procedures described above can be executed by hardware as well as by software. When the processing procedures are executed by software, a program constituting the software is installed from a recording medium to a computer incorporated in dedicated hardware or a general purpose personal computer capable of executing various functions by installing various programs.

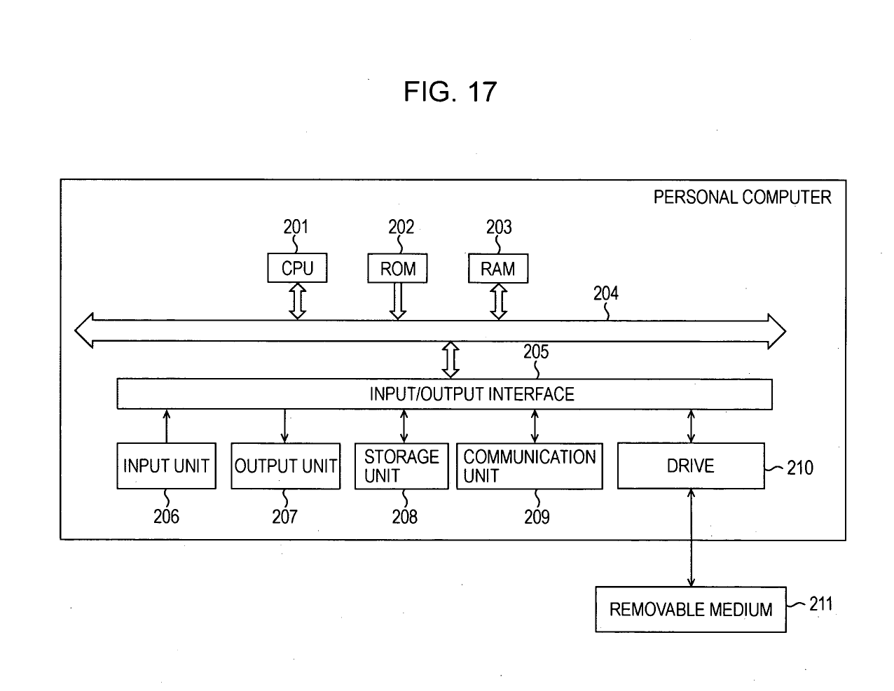

FIG. 17 is a block diagram illustrating an example of a personal computer for executing the processing procedures described above on the basis of a program. A CPU 201 performs various processing in accordance with a program stored in a ROM 202 or a storage unit 208. A program, data, or the like to be performed by the CPU 201 is stored in a RAM (random access memory) 203 as necessary. The CPU 201, the ROM 202, and the RAM 203 are interconnected via a bus 204.

The CPU 201 is also connected to an input/output interface 205 via the bus 204. The input/output interface 205 is connected to an input unit 206 including a keyboard, a mouse, a microphone, etc., and an output unit 207 including a display, a speaker, etc. The CPU 201 performs various processing in accordance with an instruction input from the input unit 206. The CPU 201 outputs the result of the processing to the output unit 207.

The input/output interface 205 is also connected to the storage unit 208. The storage unit 208 includes a hard disk, for example, to store various data and a program to be performed by the CPU 201. A communication unit 209, connected to the input/output interface 205, communicates with an external apparatus via a network such as the Internet and a local area network.

It is also possible that the program may be acquired via the communication unit 209 and stored in the storage unit 208.

When a removal medium 211 such as a magnetic disc, an optical disc, a magneto-optical disc, and a semiconductor memory is mounted on a drive 210, which is connected to the input/output interface 205, the drive 210 drives the removal medium 211 and acquires information such as a program and data stored thereon. The acquired information is transferred to the storage unit 208 so as to be stored.

This recording medium for storing the program, which is installed in a computer and can be executed by the computer, may be the removable medium 211 configured as a package medium such as, as shown in FIG. 17, a magnetic disc (including a flexible disk), an optical disc (including a CD-ROM, a DVD), a magneto-optical disk, or a semiconductor memory. The recording medium may also be the ROM 202 for temporarily or permanently storing the program or a hard disc constituting the storage unit 208. The program may be stored in the storage medium using a wire communication medium or a wireless communication medium such as a local area network, the Internet, or digital satellite broadcasting as necessary through the communication unit 209 serving as an interface such as a router or a modem.

It is noted that, in the present specification, the steps of describing the program recorded in or on a recording medium may include processing to be executed in a time series in the order as described and also includes processing to be executed parallelly or individually without being executed in a time series.

Further, in the present specification, the term “system” is used to represent an entire apparatus composed of a plurality of apparatuses.

It should be understood that changes and modifications may be made to an embodiment of the present invention within a scope that does not deviate from the gist of the present invention.

What is claimed is:

1. An information processing system including a first information processing apparatus and a second information processing apparatus,
wherein:
the first information processing apparatus comprises
storing means configured to store a predetermined content or predetermined software,
acquiring means configured to acquire the predetermined content or the predetermined software, and
transmitting means configured to transmit the acquired predetermined content or the acquired predetermined software; and
the second information processing apparatus comprises
acquiring means configured to acquire rights management information managing the use of the predetermined content or the predetermined software, from a read-only recording medium having the rights management information stored therein,
receiving means configured to receive the predetermined content or the predetermined software transmitted from the first information processing apparatus, and
executing means configured to reproduce the predetermined content or execute the predetermined software, using the rights management information.

2. An information processing apparatus comprising:
acquiring means configured to acquire rights management information managing the use of a predetermined content or predetermined software, from a read-only recording medium having stored therein the rights management information and not having stored therein the predetermined content or the predetermined software; and
executing means configured to obtain the predetermined content or the predetermined software and to reproduce the predetermined content or execute the predetermined software, using the acquired rights management information.

3. The information processing apparatus of claim 2,
wherein the executing means decrypts the predetermined content or the predetermined software, which has been encrypted, using the rights management information, so as to reproduce the predetermined content or execute the predetermined software.

4. The information processing apparatus of claim 2,
wherein:
the acquiring means further acquires information specifying the predetermined content or the predetermined software, from the read-only recording medium; and
the acquiring means further comprises receiving means configured to receive the predetermined content or the predetermined software which is specified by the acquired information.

5. The information processing apparatus of claim 4, further comprising:
storing means configured to store the received predetermined content or the received predetermined software; and
determining means configured to determine whether or not the predetermined content or the predetermined software which is specified by the information has been updated,
wherein
when the predetermined content or the predetermined software has been updated, the receiving means further receives the updated predetermined content or the updated predetermined software, and
when the predetermined content or the predetermined software has not been updated, the executing means reproduces the predetermined content stored in the storing means or executes the predetermined software stored in the storing means.

6. The information processing apparatus of claim 2,
wherein the acquiring means acquires the rights management information read out by a reading apparatus from the read-only recording medium.

7. An information processing method comprising the steps of:
acquiring rights management information managing the use of a predetermined content or predetermined software, from a read-only recording medium having stored therein the rights management information and not having stored therein the predetermined content or the predetermined software; and
obtaining the predetermined content or the predetermined software and reproducing the predetermined content or executing the predetermined software, using the acquired rights management information.

8. A program causing a computer to execute the steps of:
acquiring rights management information managing the use of a predetermined content or predetermined software, from a read-only recording medium having stored therein the rights management information and not having stored therein the predetermined content or the predetermined software; and
obtaining the predetermined content or the predetermined software and reproducing the predetermined content or executing the predetermined software, using the acquired rights management information.

9. A recording medium storing the program of claim 8.

10. An information processing apparatus comprising:
an acquiring unit configured to acquire rights management information managing the use of a predetermined content or predetermined software, from a read-only recording medium having stored therein the rights management information and not having stored therein the predetermined content or the predetermined software; and
an executing unit configured to obtain the predetermined content or the predetermined software and to reproduce the predetermined content or execute the predetermined software, using the acquired rights management information.
